(19) United States
(12) Patent Application Publication
(10) Pub. No.: US 2007/0256850 A1
(43) Pub. Date: Nov. 8, 2007

(54) Tamper resistant electrical outlet cover assembly

(76) Inventor: Cynthia L. Hansen, Voorhees, NJ (US)

Correspondence Address: JOHN F. LETCHFORD, ARCHER & GREINER, P.C., ONE CENENNIAL SQUARE, HADDONFIELD, NJ, 08033, US

(21) Appl. No.: 11/800,280

(22) Filed: May 4, 2007

Related U.S. Application Data
(60) Provisional application No. 60/797,728, filed on May 4, 2006.

(51) Int. Cl. H02G 3/14

(52) U.S. Cl. 174/66

(57) ABSTRACT

A tamper resistant electrical outlet cover assembly. The assembly includes a solid, rigid, high strength security plate constructed from a durable material and having a size and shape that preferably substantially conforms to the dimensions dictated by standard electrical outlet configurations. The plate essentially completely encloses a typical plastic cover plate of an electrical outlet. The assembly further comprises at least one security screw or other tamper resistant removable security fastener. The security fastener(s) are of a suitable size and shape to pass through at least one aperture provided in the security plate positioned in alignment with at least one dedicated electrical outlet cover fastener socket for fastening the plate thereto.

### CROSS REFERENCE TO RELATED APPLICATION

The present application claims the benefit of U.S. Provisional Patent Application No. 60/797,728, filed May 4, 2006, which is incorporated herein in its entirety by reference thereto.

### FIELD OF THE INVENTION

The present invention relates in general to devices for use in facilities having special needs for security and/or safety. Such facilities may include penal/correctional institutions such as jails, prisons, and juvenile detention centers. The invention also finds beneficial use in warehouses, psychiatric institutions, and even schools and day care centers for children. More particularly, the invention relates to tamper resistant cover assemblies for preventing access to electrical outlets.

### BACKGROUND OF THE INVENTION

Unobstructed electrical outlets with standard plastic cover plates present a safety hazard in penal and psychiatric facilities as well as in child care and education facilities. For instance, inmates and psychiatric patients have discovered that by inserting wire objects such as paperclips into an electrical outlet, they can generate enough heat to light a cigarette or even start a fire. Furthermore, these activities oftentimes cause power outages within the facility. As for child care and education facilities, exposed outlets pose an electrocution risk. In the context of warehouses and other secured areas, they may serve as unauthorized points of access to sources of electricity.

Electrical outlet safety covers are well known and assume a variety of constructions. One common class of electrical outlet safety covers encompasses those used to prevent small children from gaining access to a live outlet. While they may be useful for their dedicated purpose of protecting small children, they are easily compromised by older children and adults. If deployed in penal or mental institutions, these safety covers can be used as weapons. Moreover, they may also be ingested by inmates or psychiatric patients. As a result, they create multiple opportunities for harm to institutionalized persons and others. A somewhat more advanced variant on these devices is disclosed in U.S. Pat. No. 6,674,003 in which individual electrical outlet covers are secured to individual electrical outlet sockets via tamper proof screws that expand anchors that are received in the electrical plug grounding prong or post receiving sockets of the outlets. These devices are disadvantageous for at least two significant reasons. First, the covers are disclosed as being for use in an office environment (a generally low-security, low-impact environment) and they are formed of plastic or a similar non-conductive deformable material. These factors would essentially render the covers useless as deterrents against determined inmates or mental patients bent on removing them from electrical outlets. Second, the covers cover only the outlets themselves and not the surrounding plastic outlet cover plate. Even if a patient or inmate for some reason could not remove the outlet covers themselves, he or she could strike or kick the surrounding plastic outlet cover plate until it broke into pieces. The shards could then be used as weapons that may be used to harm the patient or inmate or others. And, it would also expose the electrical sockets that were intended to be covered in the first place.

Another common category includes outlet covers that use locked housings to limit access to electrical outlets. Examples of such devices are disclosed in U.S. Pat. Nos. 2,709,198; 2,987,909; 3,467,763; 4,584,856; 4,674,813 and 5,061,199. These devices also suffer from at least two serious deficiencies: if the operating key is lost or breaks off in the lock, the apparatus would be rendered useless.

U.S. Pat. No. 3,159,446 teaches a tamper resistant cover plate for an electrical outlet that is secured to the outlet by a security screw. The plate is intended to enclose an electrical plug at the end of an electrical cord that leads to an appliance such as a clock or radio in order to prevent theft of the device from hotel rooms, motel rooms and the like. A serious flaw in this design is that the cover plate intentionally leaves the other outlet socket fully exposed for the guest's convenience to plug in any appliance of his or her choosing. This effectively eliminates possible use of the cover plate in a high security environment.

A similar arrangement is shown in U.S. Pat. No. 4,603,931. However, in this design the user may remove the cover plate with an ordinary screwdriver. In the psychiatric and penal environments, patients and inmates are adept at fashioning crude tools that could be used as a substitute for a screwdriver. Hence, the device shown in this patent has little practical value in a security intensive environment. U.S. Pat. No. 6,479,749 discloses an “snap-on” electrical outlet cover plate that may be easily removed with a simple prying tool such as a screwdriver or the like. Like the device taught in U.S. Pat. No. 4,603,931 this device could not be effectively deployed in penal or psychiatric applications.

U.S. Pat. No. 6,908,502 describes a room deodorizer that may be secured to an electrical outlet via a security screw. This apparatus could not be practically used in a highly secured environment because the deodorizer and its mounting hardware could function as weapons if torn from the outlet. Additionally, once compromised the sockets themselves would be exposed to tampering.

Published U.S. Patent Application No. 2002/0118498 describes a device for easily installing ground fault circuit interrupter devices into conventional electrical outlets in the residential (low security, low impact) context. The device is secured to the outlet via a security screw. The housing of the ground fault circuit interrupter conversion device incorporates the face plate for the converted outlet and the face plate is made of non-conductive plastic or other non-conductive material. The shortcoming of this arrangement is that since the device is designed for the home there is no reason or suggestion of a need to strengthen the plastic face plate in any way. Consequently, the plastic housing/face plate is fully exposed to the interior of a room. If used in a penal or psychiatric facility it could be easily destroyed by a determined inmate or psychiatric patient resulting in the creation of potential weapons and exposure of the underlying electrical outlets.

An advantage exists, therefore, for a lock-less assembly including a rigid, durable, and high strength cover plate that essentially completely encloses an existing plastic electrical outlet cover plate and easily attaches to the outlet via at least one security fastener to prevent unwanted individuals from accessing the live outlet. Conversely, the outlet can be easily returned to its original state by removing the security fastener and protective exterior plate and attaching the plastic outlet cover plate to the outlet with a conventional screw or other fastener.

### SUMMARY OF THE INVENTION

The present invention provides a tamper resistant electrical outlet cover assembly. The assembly includes a solid, rigid, high strength security cover plate constructed from a durable material. The security cover plate essentially completely encloses the typical plastic cover plate of an electrical outlet. The assembly further comprises at least one security screw or other tamper resistant removable security fastener. The security fastener(s) are of a suitable size and shape to pass through at least one aperture provided in the security plate positioned in alignment with at least one dedicated electrical outlet cover fastener socket for fastening the plate thereto.

The security plate prevents psychiatric patients, prisoners or even children from placing foreign objects into electrical outlets. As for psychiatric patients and prisoners, the security plate prevents opportunities to start fires, light cigarettes, disrupt the flow of facility electricity or create opportunities (possibly by welding) to manufacture weapons or tools to self-mutilate or injure others. It also protects psychiatric patients, prisoners and children from electrocution. In the civilian, non-child care/educational sector, the cover plate prevents unauthorized use of electricity in secured areas such as warehouses and the like.

Other details, objects and advantages of the present invention will become apparent as the following description of the presently preferred embodiments and presently preferred methods of practicing the invention proceeds.

### BRIEF DESCRIPTION OF THE DRAWINGS

The invention will become more readily apparent from the following description of preferred embodiments thereof shown, by way of example only, in the accompanying drawings, wherein:

FIG. 1 is a perspective view of a tamper resistant electrical outlet cover assembly according to the present invention attached to a substrate (with a security fastener of the assembly not illustrated);

FIG. 2 is a front elevational view of a security cover plate for use in a tamper resistant electrical outlet cover assembly according to the present invention;

FIG. 3 is a cross-section view taken along line III-III of FIG. 2;

FIG. 4 is an enlarged view of the encircled portion of FIG. 3;

FIG. 5 is a partial cross-section view of a tamper resistant electrical outlet cover assembly according to the present invention attached to a substrate and enclosing a conventional two-socket electrical outlet and cover plate therefore; and

FIG. 6 is a perspective view of an exemplary security fastener suitable for use in a tamper resistant electrical outlet cover assembly according to the present invention.

### DETAILED DESCRIPTION OF THE INVENTION

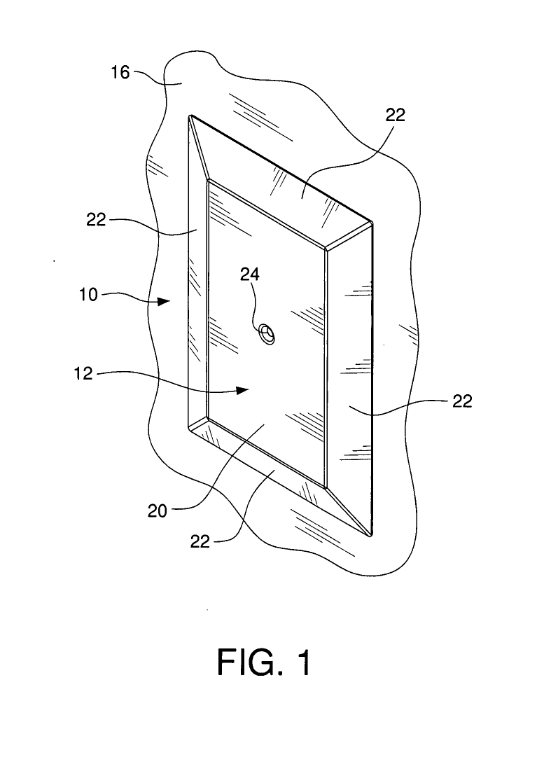

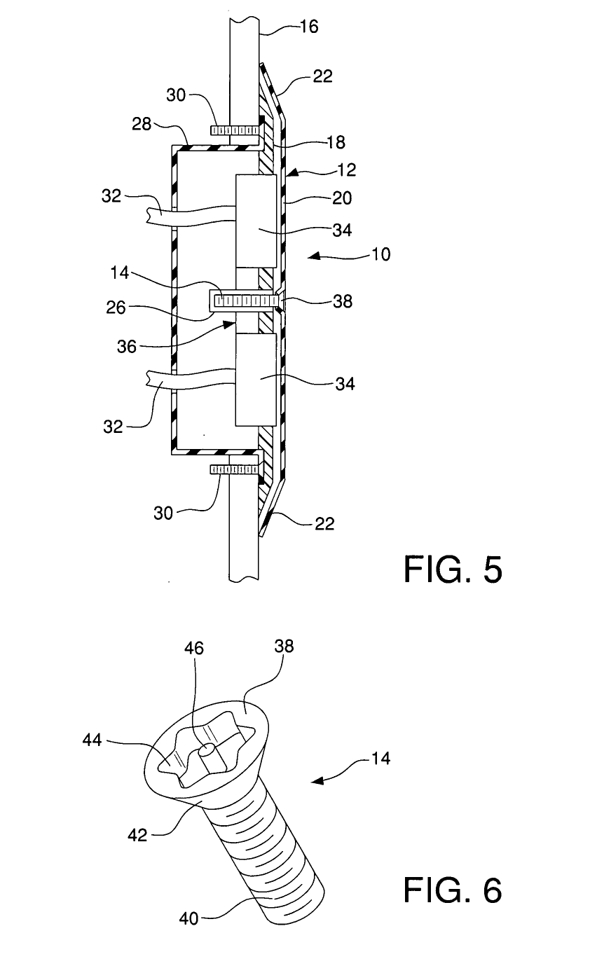

Referring to the drawings wherein like or similar references indicate like or similar elements throughout the several views, there is shown in FIG. 1 a tamper resistant electrical outlet cover assembly according to the present invention, identified generally by reference numeral 10. Assembly 10 includes a security cover plate 12 and a security fastener (which is identified by reference numeral 14 in FIGS. 5 and 6 and is described in detail in connection with the discussion of those figures) . As depicted in FIGS. 1 and 5, assembly 10 is shown attached to a substrate 16. The substrate may be any essentially planar surface such as a wall, floor or ceiling that is capable of retaining an electrical junction box that contains electrical outlet sockets in the manner known in the art.

According to the present invention, security plate 12 is a rigid, durable plate that is sized and shaped to essentially completely enclose an existing plastic electrical outlet cover plate 18 as indicated in FIG. 5. It may be made of any high strength material that is resistant to high impact and bending forces and, desirably, resistant to melting and combustion. For instance, plate 12 may be made of any suitable high strength plastic. Thermoset plastics are generally preferable to thermoplastics because of their generally higher strength and heat resistance qualities. Examples of suitable high strength thermoset plastics include, but are not limited to, cross-linked polyethylenes, alkyds, unsaturated polyesters, epoxies, melamine-formaldehydes, urea-formaldehydes, polyurethanes, phenolics and polyimides. If made of thermoset plastic, plate 12 may be fabricated using any presently known or hereinafter developed molding techniques including, without limitation, injection molding, compression molding, vacuum molding or the like. For additional strength, the plastic plate may be infused with structural reinforcement material. Such material may include glass fibers or fabrics, carbon fibers or fabrics, any high strength fibers or fabrics such, for example, Kevlar® marketed by E. I. du Pont de Nemours and Company of Wilmington, Del., USA, or Spectra® marketed by Honeywell International Inc. of Morristown, N.J., USA, exotic fibers such a spider web fibers (which have been reported to be stronger than Kevlar®), or any combination of thereof. Optionally, and preferably, a plastic plate 12 would also include one or more fire retardant additives that may be incorporated into the plastic resin or contacted with structural reinforcement fibers or fabrics, if present. Such fire retardant additives may include, without limitation, Cetaflam® marketed by Avocet Dye & Chemical Co. of West Yorkshire, England, deca bromo diphenyl oxide (DBDPO), hexa bromo cyclo dodecane (HBCD) or ammonium polyphosphate (APP).

While a high strength plastic would be suitable for use as the formation material for security plate 12, for purposes of economy and simplicity of construction, the plate is more preferably metallic and may be fabricated from any high strength metal or metal alloy. Most preferred are metals or metal alloys having good fire and corrosion resistance characteristics. For example, plate 12 may be made from powder coated, hot or cold rolled 1018 or 1020 steel. An example of a suitable metal alloy would be stainless steel. When stainless steel is used, a practical balance of cost versus strength is achieved by using either type 304 or type 316 stainless steel. The gauges (thicknesses) of metallic plate 12 may vary as may be appropriate for the metal or metal alloy selected as the formation material for the plate and may cover a wide range of thicknesses depending upon the environment in which assembly 10 will be deployed. By way of example but not limitation, for high-impact, heavy-duty environments such as penal or mental institutions, taking into consideration the cost of manufacturing the plate (i.e., thicker plates cost more to manufacture than thinner plates) a suitable gauge range for stainless steel may be from about 20 to about 16 gauge (approx. 0.036 to approx. 0.060 inch thick). A desirable combination of cost and strength has been observed using 18 gauge (approx. 0.048 inch thick stainless steel. It has be discovered that through proper formation of an 18 gauge stainless steel plate 12, as described below, the plate approximates the strength characteristics of a 16 gauge stainless steel plate.

If made of metal or metal alloy, plate 12 may be stamped or otherwise machined to assume a desirable three dimensional shape of sufficient length, width and depth to accommodate any existing plastic cover plate 18 for an electrical outlet, an example of which is depicted in FIG. 5, discussed below. More particularly, plate 12 is formed so as to define a central portion 20 and a contiguous perimeter portion 22, whereby the central portion is raised with respect to the perimeter portion. In the illustrated example, the periphery of plate 12 is generally rectangular as would be required to accommodate the cover plate of a conventional dual socket electrical outlet, although it may assume any shape to accommodate any number and arrangements of electrical outlets and their associated sockets. It is believed that the bends at the corners of the plate, which impart the spatial dimension of depth to the plate that contributes to the structural strength of the plate. The edges of the plate are preferably de-burred to eliminate metal slivers that might cause splinters and/or cuts to the installer of the assembly. And, for enhanced aesthetics; the outer surface or face of plate 12, i.e., that surface which is visible upon installation of assembly 10, may be finished with a fine grain vertical brush to produce a visual effect commonly described as a satin finish.

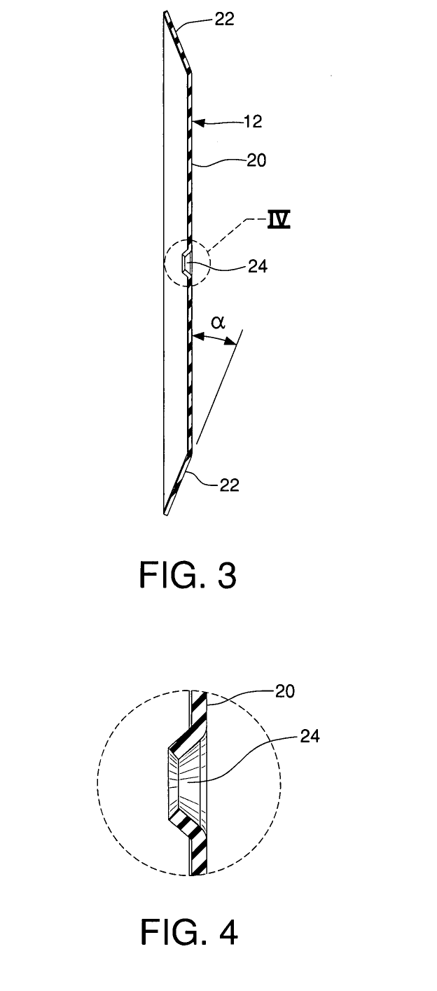

As seen in FIG. 3, the peripheral portion 22 of plate 12 extends downwardly with respect to the central portion 20 at an acute angle a. Depending on the thickness of the electrical outlet cover to be enclosed and any other relevant functional, practical or aesthetic parameters to be taken under consideration, angle a may range from about 5° to 90°. The walls of the peripheral portion 22 are depicted as being disposed at a continuous straight line slope in relation to the central portion 20. However, it is also possible that the single peripheral wall (in the case of circular or ellipsoid security plates) or multiple peripheral walls (in the case of polygonal plates such as in the illustrated embodiment) of the peripheral portion 18 may assume either a convex or concave shape.

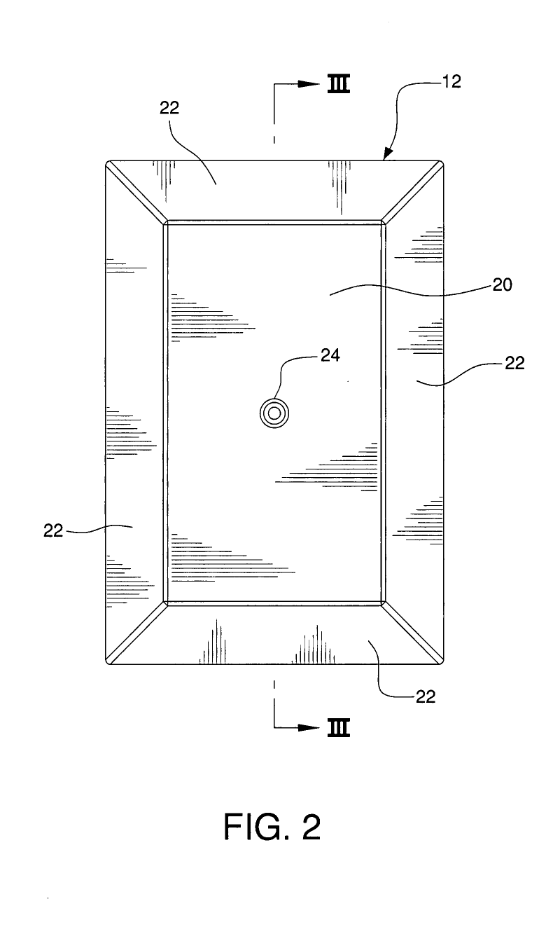

In the illustrated embodiment shown in FIGS. 1-5, plate 12 is provided with a single central aperture 24 disposed at the center of the central portion 20 so as to be in alignment with the single central electrical outlet cover fastener socket 26 (FIG. 5). As most clearly seen in FIG. 4, aperture 24 is preferably tapered and recessed with respect to the front face of central portion 20 to minimize if not eliminate projection of the head of a security fastener such as fastener 14, FIGS. 5 and 6, from protruding or projecting from the front face of plate 12 when assembly 10 is attached to a substrate.

Referring now to FIG. 5, there is shown tamper resistant electrical outlet cover assembly 10 as it would appear when attached to a substrate 16. As is known, substrate 16 is provided with an opening in which for an electrical junction box 28. The junction box, in turn, is secured to substrate 16 by screws 30 or similar fastening means. Junction box 28 is provided with openings through which electrical wiring 32 may extend from one or more sockets 34 or other region of an electrical outlet 36 to an unillustrated electrical power source. In order to install security plate 12, the original outlet cover plate fastener, typically a conventional screw (not shown), is removed from the electrical outlet cover fastener socket 26. For reasons explained below, the original outlet cover plate fastener should be stored in a known place for possible future use. With the original outlet cover plate fastener removed, security plate 12 is placed over the existing plastic outlet cover plate 18 and aperture 24 is brought into alignment with electrical outlet cover fastener socket 26. Finally, a security fastener such as security fastener 14 is inserted into electrical outlet cover fastener socket 26 and tightened to bring the peripheral portion 22 of plate 12 into firm abutting contact with the exterior face of substrate 16. So assembled, security plate 12 essentially completely encloses the existing plastic outlet cover plate 18.

FIG. 6 reveals the structural details of a removable security fastener 14 suitable for use in a tamper resistant electrical outlet cover assembly 10 constructed according to the present invention. As seen in that figure, security fastener 14 includes an enlarged tool-engageable head 38 and an integral shaft 40 extending from the head. Typically, shaft 40 is a threaded so as to be matingly received in corresponding threads provided in electrical outlet cover fastener socket 26. Additionally, the underside 42 of head 38 is desirably tapered or frustoconical in shape such that it is essentially matingly received in tapered aperture 24 of plate 12 as shown in FIG. 5.

In order to minimize the likelihood of tampering, it is preferred that the head 38 of fastener 14 not project from the front face of plate 12 once the fastener is installed in the plate. Indeed, when properly installed, the fastener head should be no worse than flush with or, more preferably, recessed with respect to the front face of the security plate.

A suitable fastener for use in assembly 10 as deployed in connection with a convention duplex electrical outlet is a 6/32×¾ flat head Torx® security machine screw. It provides the ability to remove plate 12 when the plate is installed in situations where there needs to be future accessibility to one or more of the outlet sockets 34, as discussed below. As is known, the head 38 of a Torx® security machine screw is provided with a six-sided tool socket 44 within which is disposed an upwardly directed post 46. Such a construction permits the screw to be engaged and manipulated by a matingly configured Torx® security screwdriver. The purpose of post 50 is to prevent a flat head screwdriver or other flat edge tool or piece of metal, a Phillips head screwdriver or even a conventional Torx® screwdriver from being inserted into socket 44 whereby it might be used to remove the security screw. It will be understood, however, that a Torx® security machine screw is but one type of machine screw that may be used as a security fastener according to the invention. Other possible security screws include, but are not limited to, those depicted in U.S. Pat. Nos. 3,159,446 and 6,674,003 and published U.S. Patent Application No. 2002/0118498. The only requirement is that, with regard to penal and psychiatric institutions, the security screw (or screws, if more than one screw is needed to secure the assembly), meet the approval standards established by federal, state and/or local law enforcement and/or medical/psychological authorities.

It is also possible that security fastener(s) 14 need not be screws. For example, rather than being threaded, the shaft 40 of fastener 14 may be unthreaded and provided with a radially projecting lug or dog. In that event, the interior of the electrical outlet cover fastener socket 26 would be provided with an elongated axial slot that would be contiguous with and terminate at a so-called “J-slot”. With the fastener 14 and socket 26 so constructed, the installer would first align the fastener lug with the axial slot provided in socket 26 and insert the fastener into the socket. When the lug reaches the bottom of the axial slot, the installer would then use an appropriate tool to engage the head of the fastener and apply inwardly directed axial force on the fastener head until the lug is pushed sufficiently inwardly to surmount the apex of the J-slot. While maintaining inward axial force sufficient to surmount the apex of the J-slot, the installer would then turn the fastener a distance sufficient to pass the apex of the J-slot. The installer would then disengage the tool from the fastener head whereby the lug would come to rest in the end of the J-slot under the influence of outwardly directed axial force exerted by the plate 12. As will be appreciated, when it is desired to remove the fastener the foregoing steps are reversed.

As mentioned above, certain situations arise where the security cover plate 12 needs to be removed from the substrate 16 to allow supervised use of the electrical outlet. For example, staff in psychiatric facilities may require brief periods of electrical access but must also protect a patient from danger when they are not supervised. Under these circumstances, using an appropriate security fastener insertion/removal tool, staff can temporarily remove the security cover plate 12 and reinsert the original outlet cover plate fastener to hold the plastic cover plate 18 in place while staff uses the electrical outlet socket(s) 34. When finished, staff then simply reinstalls plate 12 in the manner described above.

Relatedly, in correctional facilities, there are different requirements for housing of prisoners classified at different security and/or jurisdictional levels. For instance, there may be a situation where a federal prisoner is moved through a facility which is not usually occupied by federal prisoners. Under these circumstance, there may be federal requirements that mandate that the cell must provide a television and/or other electrically operated appliances or equipment. In that case, the cover plate 12 can be easily removed and, when the prisoner leaves the facility, easily replaced as described above.

There may also be situations in which the outlet is to be blocked from all future use. In that event, a high-strength, pick-proof adhesive/sealant such as Everseal SB190 marketed by Surebond, Inc. of Madison, Wis., USA, or other comparable product, may be placed around the periphery of plate 12 and allowed to cure whereby the plate becomes permanently affixed to the substrate.

Empirical testing by the inventor and the manufacturer of an 18 gauge stainless steel version of the tamper proof electrical outlet cover plate assembly as described herein has demonstrated that the cover plate displays little evidence of structural damage or exposure of the underlying electrical sockets when subjected to impact and bending/prying forces that are believed to be substantially greater than those that could be inflicted by even the most physically powerful and determined of inmates or mental patients Also, the instant invention has no locks and therefore needs no keys that can become lost or broken.

The tamper proof electrical outlet cover assembly illustrated and described herein has been described in connection with a well known two-socket (or duplex) electrical outlet having a cover plastic cover plate that is secured by a single, centrally disposed fastener (typically a screw). However, the invention is not so limited. That is, it is contemplated by the inventor and it will be understood by the reader that assembly 10 may be constructed to accommodate and enclose multiple two-socket electrical outlets and may have plate apertures (reference numeral 20 in several of the drawing figures) corresponding in number and in alignment with the electrical outlet cover fastener socket 26 (FIG. 5) of each such outlet. Likewise, it is further contemplated by the inventor and it will be understood by the reader that assembly 10 may be constructed to accommodate any number of electrical outlets having any number and arrangement of electrical sockets and any number and arrangement of electrical outlet cover fastener sockets.

Although the invention has been described in detail for the purpose of illustration, it is to be understood that such detail is solely for that purpose and that variations can be made therein by those skilled in the art without departing from the spirit and scope of the invention as claimed herein.

What is claimed is:

1. A lock-less tamper resistant electrical outlet cover assembly comprising:
a plate having at least one aperture positioned for alignment with at least one electrical outlet cover fastener socket, said plate being of a size and shape to essentially completely enclose an electrical outlet cover; and
at least one tamper resistant fastener of a suitable size and shape to be received in said at least one aperture for fastening said plate to at least one electrical outlet cover fastener socket.

2. The assembly of claim 1 wherein said plate is made of metal or metal alloy.

3. The assembly of claim 2 wherein said metal alloy is stainless steel.

4. The assembly of claim 3 wherein said stainless steel is either type 304 or type 316 stainless steel.

5. The assembly of claim 3 wherein said stainless steel may range from about 20 to about 16 gauge in thickness.

6. The assembly of claim 1 wherein said plate is made of plastic.

7. The assembly of claim 6 wherein said plastic is thermosetting plastic.

8. The assembly of claim 7 wherein said thermosetting plastic is selected from the group consisting of cross-linked polyethylenes, alkyds, unsaturated polyesters, epoxies, melamine-formaldehydes, urea-formaldehydes, polyurethanes, phenolics and polyimides.

9. The assembly of claim 6 wherein said plastic contains structural reinforcement material.

10. The assembly of claim 9 wherein said plastic further includes at least one fire retardant additive in contact with said high strength structural reinforcement material.

11. The assembly of claim 6 wherein said plastic contains at least one fire retardant additive.

12. The assembly of claim 1 wherein said plate comprises a central portion and a contiguous perimeter portion, said central portion being raised with respect to said perimeter portion to accommodate an electrical outlet cover, and said perimeter portion being adapted to contact a substrate in which an electrical outlet is installed.

13. The assembly of claim 12 wherein, when fully received in said at least one aperture, said at least one tamper resistant fastener is substantially flush with respect to an outer surface of said plate.

14. The assembly of claim 13 wherein, when fully received in said at least one aperture, said at least one tamper resistant fastener is recessed with respect to an outer surface of said plate.

15. A plate for use in a lock-less tamper resistant electrical outlet cover assembly, said plate comprising:
a central portion and a contiguous perimeter portion, said plate being of a size and shape to essentially completely enclose an electrical outlet cover; and
at least one aperture positioned for alignment with at least one electrical outlet cover fastener socket, said at least one aperture being adapted to receive at least one tamper resistant fastener of a size and shape suitable to fasten said plate to at least one electrical outlet cover fastener socket.

16. The plate of claim 15 wherein the plate is made of metal or metal alloy.

17. The plate of claim 16 wherein said metal alloy is stainless steel.

18. The plate of claim 17 wherein said stainless steel is either type 304 or type 316 stainless steel.

19. The plate of claim 17 wherein said stainless steel may range from about 20 to about 16 gauge in thickness.

20. The plate of claim 15 wherein the plate is made of plastic.

21. The plate of claim 20 wherein said plastic is thermosetting plastic.

22. The plate of claim 21 wherein said thermosetting plastic is selected from the group consisting of cross-linked polyethylenes, alkyds, unsaturated polyesters, epoxies, melamine-formaldehydes, urea-formaldehydes, polyurethanes, phenolics and polyimides.

23. The plate of claim 20 wherein said plastic contains structural reinforcement material.

24. The plate of claim 23 wherein said plastic further includes at least one fire retardant additive in contact with said high strength structural reinforcement material.

25. The plate of claim 20 wherein said plastic contains at least one fire retardant additive.

26. The plate of claim 15 wherein said central portion is raised with respect to said perimeter portion to accommodate an electrical outlet cover and said perimeter portion is adapted to contact a substrate in which an electrical outlet is installed.

27. The plate of claim 15 wherein said at least one aperture is of a size and shape such that, when at least one tamper resistant fastener is fully received therein, the at least one tamper resistant fastener is substantially flush with respect to an outer surface of said plate.

28. The plate of claim 27 wherein said at least one aperture is of a size and shape such that, when at least one tamper resistant fastener is fully received therein, the at least one tamper resistant fastener is recessed with respect to an outer surface of said plate.
